(19) United States
(12) Patent Application Publication
(10) Pub. No.: US 2022/0107995 A1
(43) Pub. Date: Apr. 7, 2022

(54) IINFORMATION PROCESSING APPARATUS, METHOD, AND NON-TRANSITORY RECORDING MEDIUM

(71) Applicant: Ryoh Shimomoto, Tokyo (JP)

(72) Inventor: Ryoh Shimomoto, Tokyo (JP)

(73) Assignee: Ricoh Company, Ltd., Tokyo (JP)

(21) Appl. No.: 17/448,230

(22) Filed: Sep. 21, 2021

(30) Foreign Application Priority Data
Oct. 6, 2020 (JP) 2020-169070

(51) Int. Cl. G06F 21/10; G06Q 20/12

(52) U.S. Cl. CPC G06F 21/105; G06Q 2220/18; G06Q 20/1235

(57) ABSTRACT

An information processing apparatus, a method, and a non-transitory recording medium. The information processing apparatus stores in one or more memories, one or more items of attribute information in association with a license target for each of a plurality of license targets, receives input of priority for the one or more items of attribute information, and allocates a plurality of licenses to the plurality of license targets according to the priority.

### CROSS-REFERENCE TO RELATED APPLICATIONS

This patent application is based on and claims priority pursuant to 35 U.S.C. § 119(a) to Japanese Patent Application No. 2020-169070, filed on Oct. 6, 2020, in the Japan Patent Office, the entire disclosure of which is hereby incorporated by reference herein.

### BACKGROUND

### Technical Field

The present disclosure relates to an information processing apparatus, a method, and a non-transitory recording medium.

### Related Art

A cloud service in which cloud computing provides an application through the internet is known. A license may be assigned and managed for a user or a device permitted to use such application.

### SUMMARY

Embodiments of the present disclosure describe an information processing apparatus, a method, and a non-transitory recording medium. The information processing apparatus stores in one or more memories, one or more items of attribute information in association with a license target for each of a plurality of license targets, receives input of priority for the one or more items of attribute information, and allocates a plurality of licenses to the plurality of license targets according to the priority.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an overall system configuration according to embodiments of the present disclosure;

FIG. 2 is a block diagram illustrating a hardware configuration of a license management apparatus according to embodiments of the present disclosure;

FIG. 3 is a block diagram illustrating a hardware configuration of a multifunction peripheral (MFP) according to embodiments of the present disclosure;

FIG. 4 is a block diagram illustrating a functional configuration of the license management apparatus according to embodiments of the present disclosure;

FIG. 5 is a diagram illustrating an example of data stored in a group information storage unit according to embodiments of the present disclosure;

FIG. 6 is a diagram illustrating an example of data stored in a location information storage unit according to embodiments of the present disclosure;

FIG. 7 is a diagram illustrating an example of data stored in a license information storage unit according to embodiments of the present disclosure;

FIG. 8 is a flowchart illustrating a license assigning process according to embodiments of the present disclosure;

FIG. 9 is a flowchart illustrating a license cancellation process according to embodiments of the present disclosure;

FIG. 10 is a diagram illustrating license allocation according to embodiments of the present disclosure;

FIG. 11 is a diagram illustrating a basic contract and an optional contract according to embodiments of the present disclosure;

FIG. 12 is a diagram illustrating the license allocation of the basic contract and the optional contract according to embodiments of the present disclosure;

FIG. 13 is a diagram illustrating an example of a screen displayed on a setting terminal according to embodiments of the present disclosure; and

FIG. 14 is a diagram illustrating another example of the screen displayed on the setting terminal according to embodiments of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

With reference to the drawings, embodiments of the present disclosure are described. In the following description of embodiments and drawings, the same reference numbers are allocated to elements (members or components) having the same or substantially the same function and redundant descriptions thereof are omitted.

A “tenant” is a unit including users and devices that use applications provided by cloud computing (cloud service providing apparatus 11 described below) through the internet. For example, a tenant is set for each company. A “device” is a terminal used when the cloud computing (cloud service providing apparatus 11 described below) uses an application provided through the internet. For example, the device is a multifunctional peripheral (MFP) or the like. A “group” indicates an organization (for example, a department) to which the user and the device belong. For example, the group is the department to which the user belongs or the department using the device. A “location” indicates a place to which the user and the device belong (for example, a business office). For example, the location is where the user works and where the device is installed. A “license” is a permission to use the application provided by the cloud computing (cloud service providing apparatus 11 described below) through the internet. The present disclosure can be applied when the application license is assigned only to the user, when the application license is assigned only to the device, and when the application license is assigned to both the user and the device. A “license target” is a target to which the license is assigned, such as the user or the device. “Attribute information” is information indicating attributes associated with the license target. For example, the group or location to which the user or device belongs is an example of the attribute information. The attribute information is not limited to the above description, and when the license target is the user, the attribute information may be a job type, age, gender, etc., and when the license target is the device, the attribute information may be a device type, device function, presence or absence and type of optional equipment, the number of years after the introduction of the device, and the like. One or more items of attribute information can be associated with each license target.

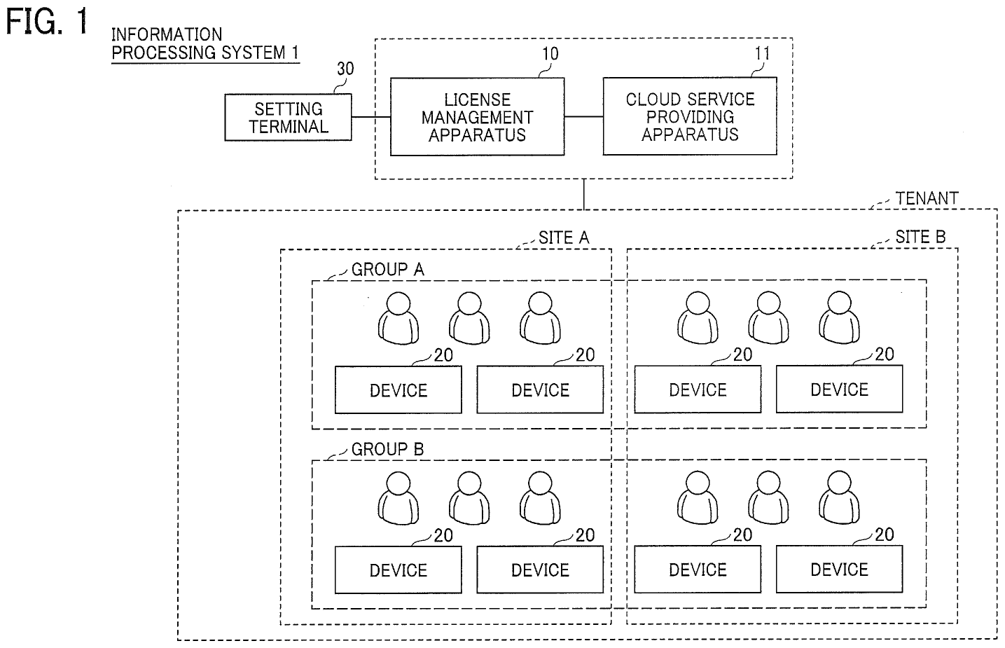

FIG. 1 is a diagram illustrating an overall system configuration according to the present embodiment. As illustrated in FIG. 1, an information processing system 1 includes a license management apparatus 10, a cloud service providing apparatus 11, one or more devices 20, and a setting terminal 30. The license management apparatus10 and the cloud service providing apparatus 11 send and receive data to and from each other through a communication network. Also, the license management apparatus 10 and the cloud service providing apparatus 11 each send and receive data to and from the device 20 through the communication network. Further, the license management apparatus 10 sends and receives data to and from the setting terminal 30 through the communication network.

As illustrated in FIG. 1, one tenant includes a plurality of users and devices classified by one or more groups (group A and group B in the example of FIG. 1) and one or more locations (site A and site B in the example of FIG. 1). One or more devices 20 are installed at each location. The user belonging to each group uses the device 20 for the group to which the user belongs among the devices installed at the location of the user. Note that the location (site, etc.) may be different even for users or devices 20 belonging to the same group (department, etc.), and the location (business) may be the same even for users or devices 20 belonging to different groups (department, etc.).

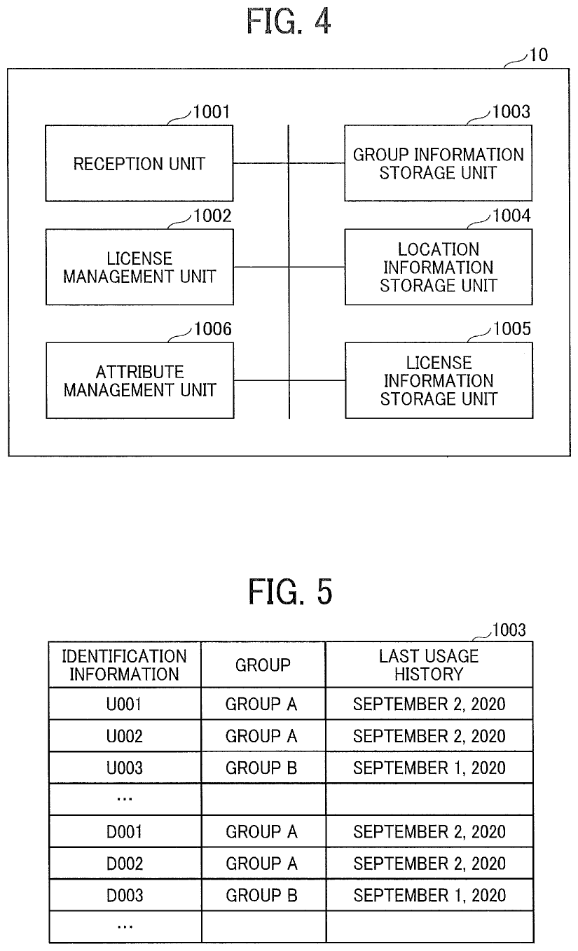

The license management apparatus (an example of the information processing apparatus) 10 assigns the user and the device 20 a license for the application provided by the cloud service providing apparatus 11. A part or all of functions of the license management apparatus 10 may be implemented in the cloud service providing apparatus 11. With reference to FIG. 4, the license management apparatus 10 is described below in detail.

The cloud service providing apparatus 11 provides the application to the device 20 through the internet. The application may be any application (for example, a storage service, a service utilizing the functions of the MFP). The cloud service providing apparatus 11 allows the user and the device 20 licensed by the license management apparatus 10 to use the application.

The device 20 is a terminal used when using the application provided by the cloud service providing apparatus 11. For example, the device is an MFP or the like.

The device 20 is not limited to an image forming device such as the MFP as long as the device includes a communication function. The device 20 includes, for example, an output device such as a projector (PJ), an interactive whiteboard (IWB; an electronic whiteboard having mutual communication capability), and a digital signage, a head-up display (HUD), an industrial machine, an imaging device, a sound collecting device, a medical device, a networked home appliance, an automobile (connected car), a laptop personal computer (PC), a mobile phone, a smartphone, a tablet terminal, a game console, a personal digital assistant (PDA), a digital camera, a wearable PC and a desktop PC.

The setting terminal 30 is a terminal for setting the license for the application provided by the cloud service providing apparatus 11. For example, a sales representative of the device 20 or a contract administrator of each group (a person who manages the assigning of a license to the user of each group and the device 20) operates the setting terminal 30. For example, the setting terminal 30 is a PC or the like.

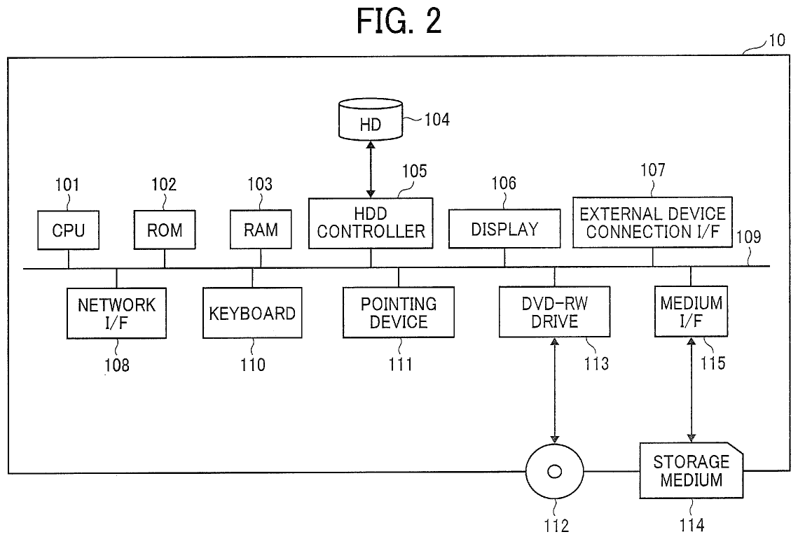

FIG. 2 is a block diagram illustrating a hardware configuration of the license management apparatus 10 according to the present embodiment. Note that the cloud service providing apparatus 11 and the setting terminal 30 may have the same hardware configuration.

As illustrated in FIG. 2, the license management apparatus 10 is implemented by a computer and includes a central processing unit (CPU) 101, a read only memory (ROM) 102, a random access memory (RAM) 103, a hard disk (HD) 104, a hard disk drive (HDD) controller 105, a display 106, an external device connection interface (I/F) 107, a network I/F 108, a bus line 109, a keyboard 110, a pointing device 111, a digital versatile disk-rewritable (DVD-RW) drive 113, and a medium I/F 115.

The CPU 101 controls overall operation of the license management apparatus 10. The ROM 102 stores a control program such as an initial program loader (IPL) to boot the CPU 101. The RAM 103 is used as a work area for the CPU 101. The HD 104 stores various data such as a control program. The HDD controller 105 controls reading or writing of various data from or to the HD 104 under the control of the CPU 101. The display 106 displays various information such as a cursor, menu, window, characters, or image. The external device connection I/F 107 is an interface for connecting various external devices. The external device in this case is, for example, a universal serial bus (USB) memory or a printer. The network I/F 108 controls data communication performed with an external device through the communication network. The bus line 109 is, for example, an address bus or a data bus, which electrically connects the elements such as the CPU 101 illustrated in FIG. 2.

The keyboard 110 is an example of an input device provided with a plurality of keys for allowing a user to input characters, numerals, or various instructions. The pointing device 111 is an example of an input device that allows a user to select or execute a specific instruction, select a target for processing, or move a cursor being displayed. The DVD-RW drive 113 reads and writes various data from and to a DVD-RW 112, which is an example of a removable storage medium. The removable storage medium is not limited to the DVD-RW and may be a digital versatile disc-recordable (DVD-R) or the like. The medium I/F 115 controls reading or writing (storage) of data to a storage medium 114 such as a flash memory.

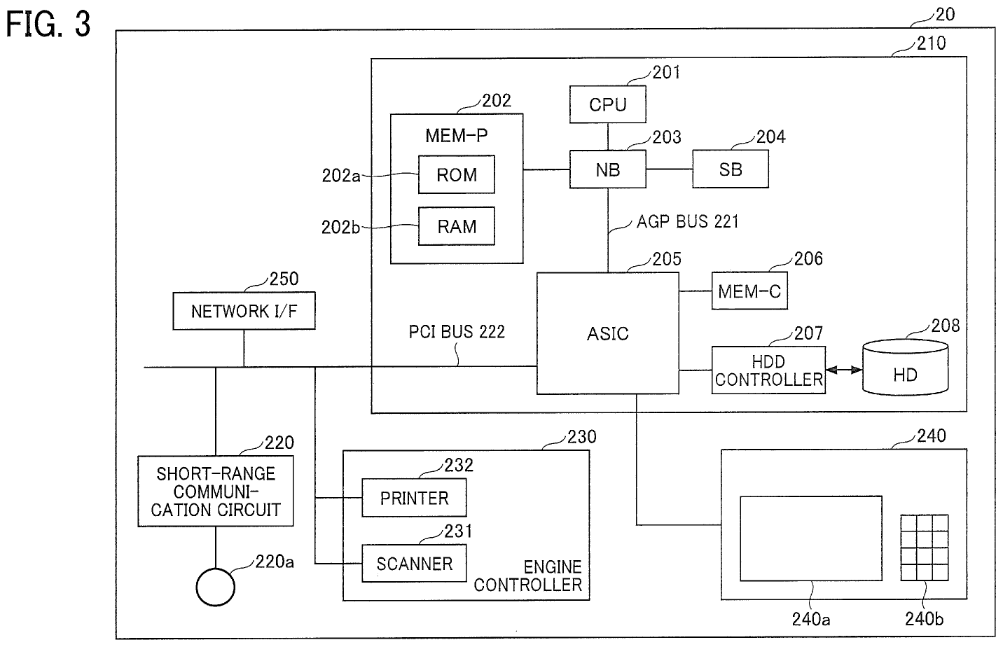

FIG. 3 is a block diagram illustrating a hardware configuration of the MFP as an example of the device 20 according to the present embodiment.

As illustrated in FIG. 3, the MFP 20 includes a controller 210, a short-range communication circuit 220, an engine controller 230, a control panel 240, and a network I/F 250.

The controller 210 includes a CPU 201 which is the main part of the computer, a system memory (MEM-P) 202, a north bridge (NB) 203, a south bridge (SB) 204, an Application Specific Integrated Circuit (ASIC) 205, a local memory (MEM-C) 206 as a storage, an HDD controller 207, and an HD 208 as a storage unit. The NB 203 and the ASIC 205 are connected by an AGP (Accelerated Graphics Port) bus 221.

The CPU 201 is a control unit that controls the entire MFP 20. The NB 203 is a bridge for connecting the CPU 201, the MEM-P 202, the SB 204, and the AGP bus 221. The NB 203 includes a memory controller that controls reading/writing of the MEM-P 202, a peripheral component interconnect (PCI) master, and an AGP target.

The MEM-P 202 includes a ROM 202a as a memory that stores program and data for implementing various functions of the controller 210. The MEM-P 202 further includes a RAM 202b as a memory that deploys the program and data, or as a rendering memory that stores rendering data for printing. The program stored in the RAM 202b may be stored in any computer-readable storage medium, such as a compact disc-read only memory (CD-ROM), compact disc-recordable (CD-R), or digital versatile disc (DVD), in a file format installable or executable by the computer for distribution.

The SB 204 connects the NB 203 with a peripheral component interconnect (PCI) device or a peripheral device. The ASIC 205 is an integrated circuit (IC) for image processing applications having hardware elements for image processing, and connects AGP bus 221 and PCI bus 222, HDD controller 207, and MEM-C 206, respectively. The ASIC 205 includes a PCI target, an AGP master, an arbiter (ARB) as a central processor of the ASIC 205, a memory controller for controlling the MEM-C 206, a plurality of direct memory access controllers (DMACs) capable of converting coordinates of image data with a hardware logic, and a PCI unit that transfers data between a scanner 231 and a printer 232 through the PCI bus 222. The ASIC 205 may be connected to a USB interface, or an Institute of Electrical and Electronics Engineers 1394 (IEEE1394) interface.

The MEM-C 206 is a local memory used as a buffer for image data to be copied or a code buffer. The HD 208 stores various image data, font data for printing, and form data. The HDD controller 207 controls reading or writing of data to the HD 208 according to the control of the CPU 201. The AGP bus 221 is a bus interface for a graphics accelerator card, which has been proposed to accelerate graphics processing. Through directly accessing the MEM-P 202 by high-throughput, speed of the graphics accelerator card is improved.

The short-range communication circuit 220 includes an antenna for short-range communication circuit 220a. The short-range communication circuit 220 communicates in compliance with, for example, the Near Field Communication (NFC) or the BLUETOOTH.

The engine controller 230 includes a scanner 231 and a printer 232. The control panel 240 includes a display panel 240a and an operation panel 240b. The display panel 240a is implemented by, for example, a touch panel that displays current settings or a selection screen and receives a user input. The operation panel 240b includes a numeric keypad that receives set values of various image forming parameters such as image density parameter and a start key that accepts an instruction for starting copying. The controller 210 controls entire operation of the MFP 20. For example, the controller 210 controls rendering, communication, or user inputs to the control panel 240. The scanner 231 or the printer 232 includes an image processing unit such as error diffusion processing and gamma conversion processing.

In response to an instruction to select a specific application through the control panel 240, for example, using a mode switch key, the MFP 20 selectively performs a document box function, a copy function, a print function, and a facsimile function. The document box mode is selected when the document box function is selected, the copy mode is selected when the copy function is selected, the printer mode is selected when the printer function is selected, and the facsimile mode is selected when the facsimile function is selected.

The network I/F 250 is an interface that controls communication of data through the communication network. The short-range communication circuit 220 and the network I/F 250 are electrically connected to the ASIC 205 through the PCI bus 222.

FIG. 4 is a block diagram illustrating a functional configuration of the license management apparatus 10 according to the present embodiment. The license management apparatus 10 includes a reception unit 1001, an attribute management unit 1006, a license management unit 1002, a group information storage unit 1003, a location information storage unit 1004, and a license information storage unit 1005. The license management apparatus 10 functions as the reception unit 1001, the attribute management unit 1006, and the license management unit 1002 by executing a program.

The reception unit 1001 receives settings of the license of the application provided by the cloud service providing apparatus 11. Specifically, the reception unit 1001 displays a screen on the setting terminal 30 for inputting priority of the group and the location when allocating the license. In addition, the reception unit 1001 acquires the group and location priority information input to the setting terminal 30 from the setting terminal 30. The present disclosure can be applied when the application license is assigned only to the user, when the application license is assigned only to the device, and when the application license is assigned to both the user and the device.

In addition, the reception unit 1001 receives input of attribute information indicating the group and the location for each user and device.

Before describing the license management unit 1002, the information in each storage unit is described. In the following description, a case where the group and the location are used for the license allocation as the attribute information is described, but when other attribute information is used for the license allocation, a storage unit may be provided for other attribute information.

The group information storage unit 1003 stores information on one or more groups (departments, etc.) belonging to each tenant. Specifically, the group information storage unit 1003 stores information on the group to which the user of each tenant belongs (that is, information on which group the user belongs to) and the group to which the device 20 of each tenant belongs (that is, information on which group the device 20 belongs to).

FIG. 5 is an example of group information stored in the group information storage unit 1003. The group information can be stored for each tenant. The identification information identifies the user or the device. The identification information with an acronym U indicates the user, and the identification information with the acronym D indicates the device. The group indicates the group to which the user or device belongs. The group to which the user and the device belong can be registered and edited by the setting terminal 30 accessing the license management apparatus 10. The last usage history is the date and time when the user or device last used the application. If the tenant has a license for a plurality of applications, the last usage history can be stored for each license or each application. Note that FIG. 5 illustrates a case where the group information related to the user and the group information related to the device are stored in the same storage unit, but the present disclosure is not limited to this configuration and the group information may be stored in different storage units.

Although the last usage history is stored in the group information storage unit 1003, the last usage history may be stored in the location information storage unit 1004 or may be stored in a different storage unit.

The location information storage unit 1004 stores location information (information on site, etc.) of each tenant. Specifically, the location information storage unit 1004 stores information on the location to which the user of each tenant belongs (that is, information on which location the user belongs to) and the location to which the device 20 of each tenant belongs (that is, information on which location the device 20 belongs to).

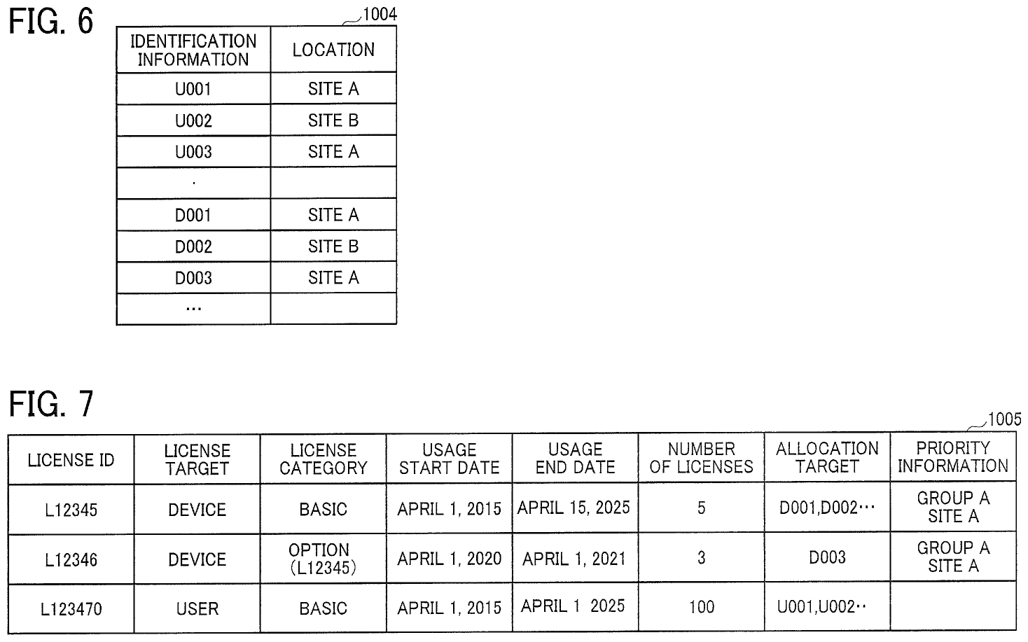

FIG. 6 is an example of the location information stored in the location information storage unit 1004. The location information can be stored for each tenant. The identification information identifies the user or the device. The identification information with the acronym U indicates the user, and the identification information with the acronym D indicates the device. The location is information that indicates the place of business or location to which the user or device belongs. The location to which the user and the device belong can be registered and edited by the setting terminal 30 accessing the license management apparatus 10.

The license information storage unit 1005 stores license information for each application. Specifically, the license information storage unit 1005 stores information (whether the user and the device 20 are licensed) of the user and the device 20 licensed by the license management unit 1002 for each application. The cloud service providing apparatus 11 allows the user and the device 20 licensed by the license management apparatus 10 to use the application based on the information in the license information storage unit 1005. The license information storage unit 1005 may be implemented in the cloud service providing apparatus 11.

FIG. 7 is an example of the license information stored in the license information storage unit 1005. The license information can be stored for each tenant. A license ID identifies the license. A license target indicates a target to which the license is assigned. For example, a “device” indicates a device license that can be assigned only to the device, and a “user” indicates a user license that can be assigned only to the user. In addition, there may be a license that can be assigned to both the device and the user. A license category indicates whether the license is based on a basic contract or an optional contract. When the license category is the optional contract, information indicating which basic contract the optional contract is associated with may be stored. A usage start date is a date when the license became valid. A usage end date is an expiration date of the license. A number of licenses is the upper limit of the number of devices or users to which the license can be assigned. An allocation target indicates the device or user to which the license has been assigned. Priority information is information indicating the priority used when assigning or canceling the license. The license information may store information indicating which application the license is related to.

The attribute management unit 1006 manages the attribute information for each license target received by the reception unit 1001. For example, when the group to which the user or device belongs is set for the user or device, information indicating the group is stored in the group information storage unit 1003 in association with the user or device. When the location to which the user or device belongs is set for the user or device, the information indicating the location is stored in the location information storage unit 1004 in association with the user or device. Further, when other attribute information is set, the other setting information can be stored in the storage unit. The attribute management unit 1006 can receive and store the attribute information for each user or device at the timing of registering the user or device in the tenant, for example, but the attribute information can be changed, deleted, or added at any time.

The license management unit 1002 assigns and cancels the license of the application provided by the cloud service providing apparatus 11. Hereinafter, the assigning of the license and the cancellation of the license are described separately.

The license management unit 1002 refers to the group information storage unit 1003 and the location information storage unit 1004 and allocates the license to the user and the device 20 according to the priority received by the reception unit 1001. Note that the license may be assigned only to the user, the license may be assigned only to the device 20, or the license may be assigned to both the user and the device 20.

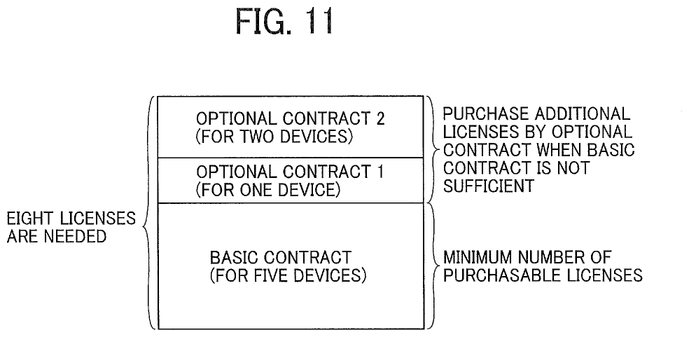

The license management unit 1002 cancels the license of a certain user and a certain device 20 among the users and devices 20 to which the license has been assigned. (Note that only the user's license may be canceled, only the device 20 license may be canceled, or both the user and device 20 licenses may be canceled). For example, the license management unit 1002 can cancel the license when the optional contract (described with reference to FIG. 11) has expired. A first, second, and third examples of cancelling the license are described in the following.

In the first example, the license management unit 1002 refers to the license information storage unit 1005 and cancels the license (the licenses assigned automatically) of the user or the device 20 that is assigned by the license management unit 1002.

In the second example, the license management unit 1002 stores the priority information (that is, the priority of the group and the location) when the license management unit 1002 assigns the license and cancels the license in order from the user or the device 20 belonging to the group and location with the lowest priority.

In the third example, the license management unit 1002 stores the priority information (that is, the priority of the group and the location) when the license management unit 1002 assigns the license and cancels the license in order from the user and the device 20 that belong to the group and location with the lowest priority and have the longest period since the last use of the application.

Specifically, the license management unit 1002 searches for the user and the device 20 to which the license has been assigned. Then, the license management unit 1002 arranges the searched users and devices 20 in ascending order of priority of license allocation. Further, the license management unit 1002 arranges the users and the devices 20 having the same priority in the order from the user and the device with the longest period since the last use of the application. The license management unit 1002 cancels the license in order from the user and the device 20 having the lower priority and the longer period since the last use of the application.

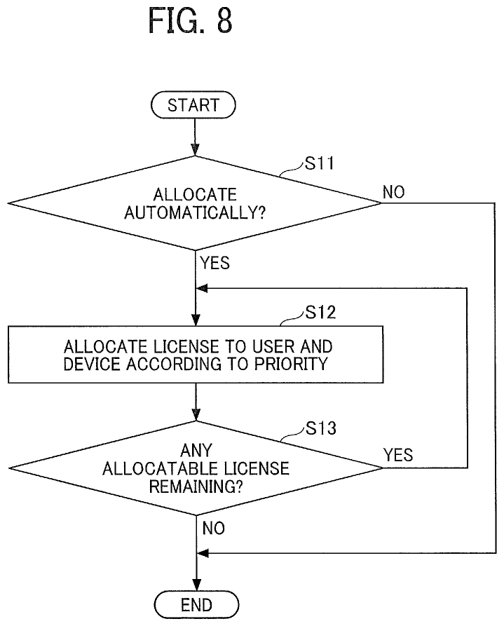

FIG. 8 is a flowchart illustrating a license assigning process according to the present embodiment.

In step S11, the license management unit 1002 determines whether to allocate the license automatically. When the license is to be assigned automatically, the process proceeds to step S12, and when the license is not to be assigned automatically, the process ends. For example, whether the license is to be assigned automatically may be determined for each application or for each tenant.

In step S12, the license management unit 1002 refers to the group information storage unit 1003 and the location information storage unit 1004 and allocates licenses to the user and the device 20 according to the priority received by the reception unit 1001. Note that the license may be assigned only to the user, the license may be assigned only to the device 20, or the license may be assigned to both the user and the device 20.

In step S13, the license management unit 1002 determines whether an allocatable license is remaining after the allocation in step S12. When the allocatable license is remaining, the process returns to step S12, and when there is no allocatable license remaining, the process ends.

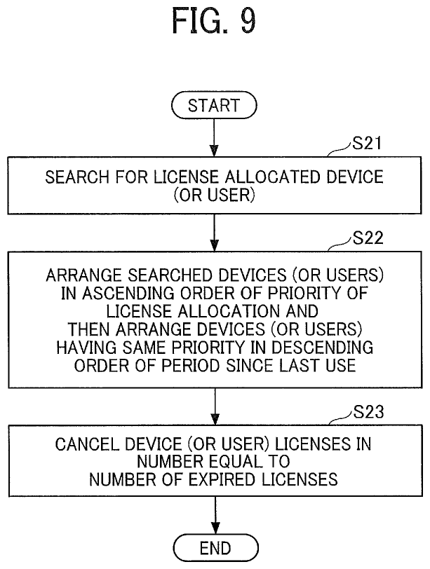

FIG. 9 is a flowchart illustrating a license cancellation process according to the present embodiment.

In step S21, the license management unit 1002 searches for the device 20 (or user) to which the license has been assigned.

In step S22, the license management unit 1002 arranges the devices 20 (or users) found in step S21 in ascending order of priority of license allocation. Then, the license management unit 1002 arranges the devices 20 (or users) having the same priority in descending order of the period since the last use of the application.

In step S23, the license management unit 1002 cancels the license of the device 20 (or user) for the number of licenses for which the optional contract has expired in order from device 20 (or user) which has the lowest priority and the longest period since the application was last used, referring to the arrangement made in step S22. When the basic contract is already expired, the contract including the optional contract is terminated and all licenses are cancelled.

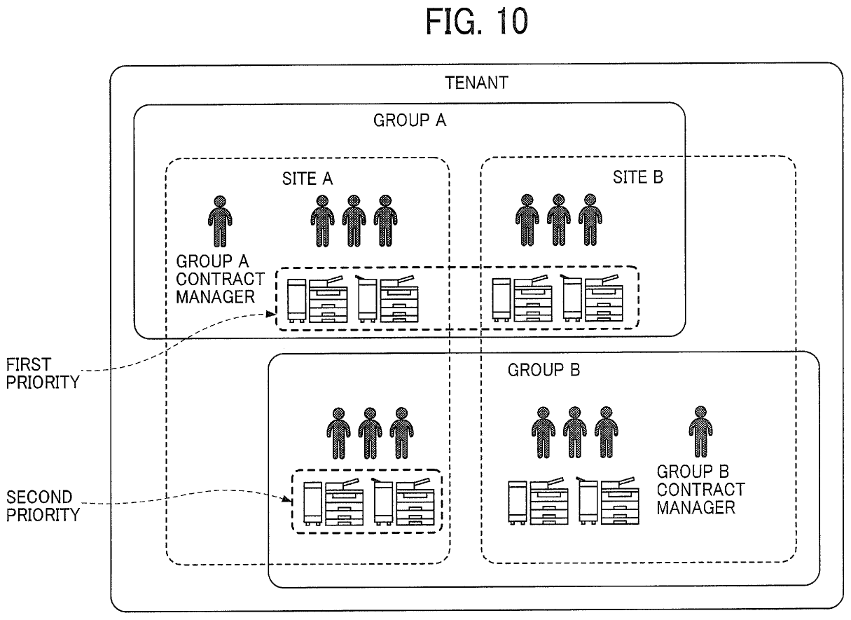

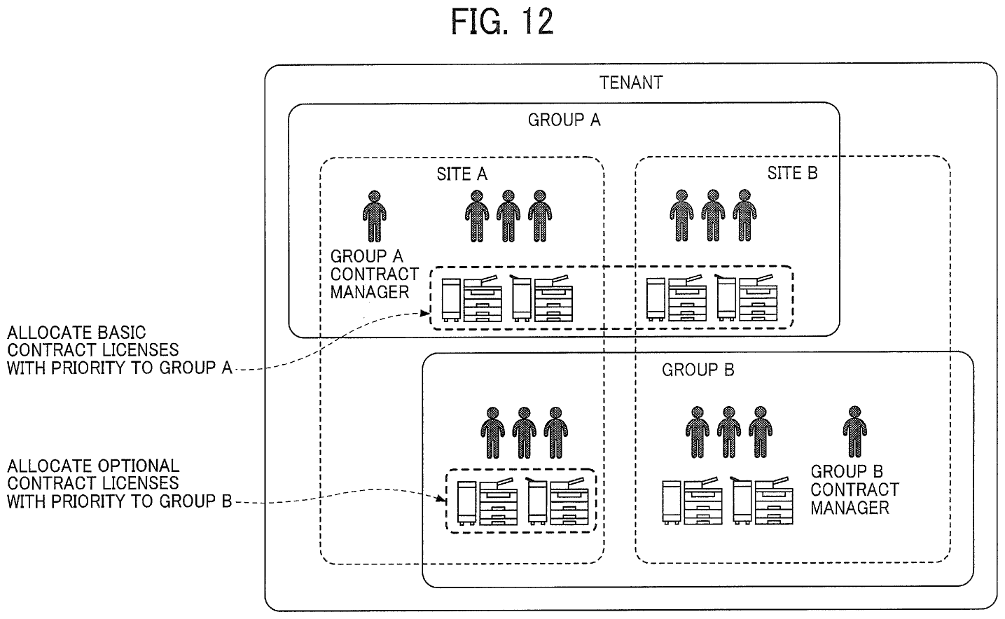

Hereinafter, with reference to FIG. 10, the allocation of licenses according to the embodiment of the present disclosure is described and with reference to FIGS. 11 and 12, the allocation of licenses in the basic contract and the optional contract according to the embodiment of the present disclosure is described.

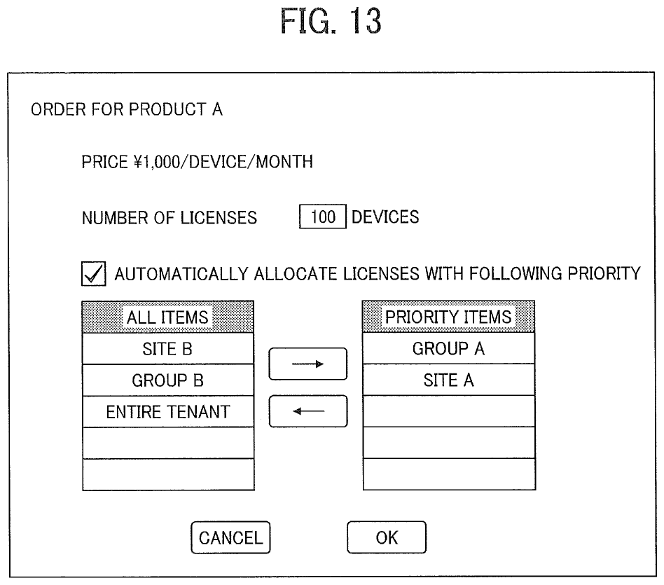

FIG. 10 is a diagram illustrating license allocation according to the present embodiment. For example, assume that the device of group A has the highest priority, and the device of site A has the second highest priority. (For example, assume that the order is made as illustrated in the screen of FIG. 13). Then, the license is first assigned to the device in group A regardless of the location. Next, if the allocatable license is remaining, the license is also assigned to the device in site A (that is, the device of the site A other than the group A (group B)). In this case, the license is not assigned to the device of the site B of the group B.

FIG. 11 is a diagram illustrating a basic contract and an optional contract according to the present embodiment. The basic contract and the optional contract are available for the application provided by the cloud service providing apparatus 11.

The basic contract is a contract for the tenant to use the application. The basic contract defines the minimum number of licenses (fixed number) that can be purchased (in the example of FIG. 11, 5 devices).

The optional contract accompanies the basic contract, which indicates that the optional contract cannot be concluded without the basic contract. When necessary number of licenses are not included in the basic contract, the tenant purchases additional licenses through the optional contract. In the example of FIG. 11, one license is additionally purchased by the optional contract 1, and two licenses are purchased by the optional contract 2.

In one embodiment of the present disclosure, when the application provided by the cloud service providing apparatus 11 includes the basic contract and the optional contract, the priority of license allocation can be set for each contract (each of the basic contract and the optional contract).

FIG. 12 is a diagram illustrating the license allocation of the basic contract and the optional contract according to the present embodiment. Assume that the contract administrator of group A concludes the basic contract and preferentially allocates the license to group A. After that, when the contract administrator of group B additionally purchases the license by the optional contract, the license can be preferentially assigned to the group B (that is, a priority different from the basic contract is set).

FIG. 13 is a diagram illustrating an example of a screen displayed on the setting terminal 30 according to the present embodiment. For example, when the sales representative of the device 20 or the contract administrator of the tenant operates the setting terminal 30, the screen of FIG. 13 is displayed. As illustrated in FIG. 13, the sales representative of the device 20 or the contract administrator of the tenant license can prioritize groups and locations when assigning licenses for the application when the tenant orders the application (“Product A” in the example of FIG. 13). In the example of FIG. 13, the licenses for 100 devices are first assigned preferentially to the devices of group A, and then preferentially assigned to the devices of the site A. When “entire tenant” is selected, licenses are automatically assigned to the users and devices 20 owned by the tenant. For example, when the number of devices registered in the tenant is less than the number of licenses (100 devices in the example), licenses can be assigned to all the devices registered in the tenant. On the other hand, when the number of devices registered in the tenant is larger than the number of licenses, the licenses can be assigned according to predetermined conditions. For example, licenses may be assigned according to the predetermined conditions such as ascending order of device IDs and registration order of devices.

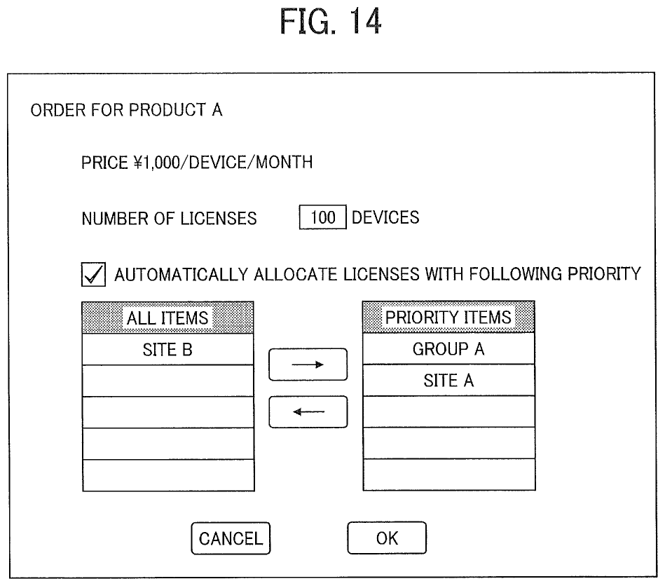

FIG. 14 is a diagram illustrating an example of the screen displayed on the setting terminal 30 according to the present embodiment. For example, when the contract administrator of each group (the person who manages the assigning of licenses to the users and devices of each group) operates the setting terminal 30, the screen of FIG. 14 is displayed. As illustrated in FIG. 14, the contract administrator of each group (assumed to be the contract administrator of group A in FIG. 14) can set priority of groups and locations for assigning licenses for the application when the tenant orders the application (“Product A” in the example of FIG. 14).

The screen of FIG. 14 is different from the screen of FIG. 13, and a group that is not a group managed by the contract administrator (group B in the example of FIG. 14) is not displayed as an option when setting the priority. On the other hand, the device at the location to which the user managed by the contract administrator belongs (in the example of FIG. 14, the device 20 of the site A and the device 20 of the site B) are displayed as options when setting the priority so that the device can be used by the user managed by the contract administrator. That is, the device 20 of the group that is not the group managed by the contract administrator (in the example of FIG. 14, the device 20 of the site A of the group B and the device 20 of the site B of the group B) is displayed as an option when setting the priority. Note that “entire tenant”, which is beyond the scope of the contract administrator's authority, is not displayed as an option when setting the priority.

In the above, a case where the sales representative of the device 20 or the contract administrator sets the priority when applying for the use of the application has been described, but the timing for setting the priority is not limited to this example. For example, the sales representative of the device 20 or the contract administrator of the tenant may set the priority after applying for the use of the application. The setting terminal 30 can access the license management apparatus 10 at any time to change the user or device to which the license is assigned.

In one embodiment of the present disclosure, licenses can be easily assigned to the group and location to which the user and device 20 belong. Further, in one embodiment of the present disclosure, the licenses of the user and the device 20 can be easily cancelled according to the priority of license allocation.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. An information processing apparatus comprising:
circuitry configured to:
store in one or more memories, one or more items of attribute information in association with a license target for each of a plurality of license targets;
receive input of priority for the one or more items of attribute information; and
allocate a plurality of licenses to the plurality of license targets according to the priority.

2. The information processing apparatus of claim 1, wherein
the license target includes at least one of a device or a user.

3. The information processing apparatus of claim 2, wherein
the attribute information includes at least one of a group to which the device or the user belongs or a location to which the device or the user belongs.

4. The information processing apparatus of claim 3, wherein
the circuitry is configured to allocate the plurality of licenses to a plurality of devices, each device belonging to a group other than a particular group among a plurality of groups and belonging to a location to which a user of the particular group belongs.

5. The information processing apparatus of claim 1, wherein
the circuitry is configured to allocate the plurality of licenses of an application to the plurality of license targets according to the priority of the attribute information for each of a basic contract and an optional contract of the application.

6. The information processing apparatus of claim 1, wherein
the circuitry is further configured to cancel at least one of the licenses assigned to the plurality of license targets.

7. The information processing apparatus of claim 1, wherein
the circuitry is further configured to:
store in one or more memories information on the priority of the attribute information having been set when the license is allocated; and
cancel the at least one license in order from the license target associated with the attribute information having the lowest priority.

8. The information processing apparatus of claim 1, wherein
the circuitry is further configured to:
store in one or more memories information on the priority of the attribute information having been set when the license is allocated; and
cancel the at least one license of the license target, in order from the license target associated with the attribute information having the lowest priority and having the longest period of time since the last use of application.

9. A method comprising:
storing in one or more memories, one or more items of attribute information in association with a license target for each of a plurality of license targets;
receiving input of priority for the one or more items of attribute information; and
allocating a plurality of licenses to the plurality of license targets according to the priority.

10. A non-transitory recording medium which, when executed by one or more processors on an information processing apparatus, cause the processors to perform a method comprising:
storing in one or more memories, one or more items of attribute information in association with a license target for each of a plurality of license targets;
receiving input of priority for the one or more items of attribute information; and
allocating a plurality of licenses to the plurality of license targets according to the priority.
